(19) United States
(12) Patent Application Publication
(10) Pub. No.: US 2018/0101507 A1
(43) Pub. Date: Apr. 12, 2018

(54) METHOD AND SYSTEM FOR BYPASSING AD-BLOCKING TECHNOLOGY

(71) Applicant: Red Spark, LP, Philadelphia, PA (US)

(72) Inventor: Gabriel Malca, Cote-Saint-Luc (CA)

(73) Assignee: Red Spark, LP, Philadelphia, PA (US)

(21) Appl. No.: 15/729,244

(22) Filed: Oct. 10, 2017

Related U.S. Application Data
(60) Provisional application No. 62/406,237, filed on Oct. 10, 2016.

(51) Int. Cl. G06F 17/22; G06F 17/30; G06Q 30/02; G06F 17/21

(52) U.S. Cl. CPC G06F 17/2247; G06F 17/211; G06Q 30/0277; G06F 17/30887

(57) ABSTRACT

Methods, systems, and apparatuses are described herein for bypassing ad-blocking technology. The anti-ad-blocking system described herein may create a Binary Large Object (BLOB) object that includes HyperText Markup Language (HTML) code to be executed. An object uniform resource locator (URL) may be created that references the HTML code. The anti-ad-blocking system may create an iframe at a location on an HTML document, corresponding to the location where advertising content should be displayed on a webpage, to render content and set the source of the iframe to the object URL. Then, when the HTML code is executed, a request for content may be sent and the received content may be rendered via a web browser.

### CROSS REFERENCE TO RELATED APPLICATION

This application claims the benefit of U.S. provisional application No. 62/406,237, filed Oct. 10, 2016, which is incorporated by reference as if fully set forth.

### FIELD OF THE INVENTION

The present application is related to methods and systems for bypassing ad-blocking technology.

### BACKGROUND

Website publishers often monetize their sites with advertising to offset operational costs such as server costs, domain registration, content creation, design, development, and more, which allows web users to consume online content for free. On the other hand, advertisers including agencies, brands, and large advertising exchanges rely on digital advertising to target their demographic online with relevant information, promote brand awareness, and maintain customer loyalty.

In recent years, ad-blocking technology has become increasingly popular, as some users wish to access and consume online content for free without seeing the advertisements that are also present on those webpages. Part of the motivation may be due to certain websites utilizing too many ads, or intrusive types of ads that overwhelm the other content on the page or cause issues such as slow page load times. Taken as a whole, the increased use of ad-blockers severely disrupts the advertising and publishing industry by preventing online ads from being shown and consequently taking revenues away from online publishers, making it increasingly difficult for those publishers to continue offering content for free. Browser extensions, browser settings, antivirus programs, and router add-ons are a few methods of blocking online ads.

The technology that identifies and blocks ads varies by product, but the most popular ad-blockers refer to a crowdsourced blacklist of domains that serve ads, while allowing ads that have been deemed acceptable or content that has been identified as being non-ad related. Acceptable ads may be determined by user studies, but also include companies that pay the ad-blocker to be whitelisted. Images of certain sizes commonly identified as ads, elements like social sharing widgets, and other content and features that may or may not be advertising can potentially be blocked by some ad-blockers.

Ad-blocking prevents certain code, commonly referred to as ad tags, from loading on a website, including third-party ad tags and analytics tracking code that help website publishers analyze visitor activity on their site. Without the ability to collect visitor data, publishers cannot effectively optimize their websites, which can hurt their monetization strategies, search engine ranking, and visitors' user experience.

Advertisers and publishers are constantly devising new strategies to compensate for ad-block-related revenue losses, including increasing the number of ads on a page, integrating ads into content in a way that is not recognized by ad-blockers, and making ads more intrusive. Some websites restrict content entirely for visitors with ad-blocking enabled. These methods often create frustrating user experiences for visitors. Accordingly, there is a need for technology to bypass ad-blockers.

### SUMMARY

Methods, systems, and apparatuses are described herein for bypassing ad-blocking technology. The anti-ad-blocking system described herein may create a Binary Large Object (BLOB) object that includes HyperText Markup Language (HTML) code to be executed. An object uniform resource locator (URL) may be created that references the HTML code. The anti-ad-blocking system may create an iframe at a location on an HTML document, corresponding to the location where advertising content should be displayed on a webpage, to render content and set the source of the iframe to the object URL. Then, when the HTML code is executed, a request for content may be sent and the received content may be rendered via a web browser.

### BRIEF DESCRIPTION OF THE DRAWINGS

A more detailed understanding may be had from the following description, given by way of example in conjunction with the accompanying drawings wherein:

FIG. 1 is a system diagram of the high level architecture of an exemplary system implementing the anti-ad-blocking system;

FIG. 2 is an example flow diagram of the process that runs the anti-ad-blocking system; and

FIG. 3 is an example flow diagram of the process that runs the anti-ad-blocking system performed by a client device.

### DETAILED DESCRIPTION

Certain terminology is used in the following description for convenience only and is not limiting. The terms “a” and “one” are defined as including one or more of the referenced item unless specifically noted otherwise. A reference to a list of items that are cited as “at least one of a, b, or c” (where a, b, and c represent the items being listed) means any single one of the items a, b, or c, or combinations thereof. The terminology includes the words specifically noted above, derivatives thereof, and words of similar import. It is to be understood that the figures and descriptions of the present application have been simplified to illustrate elements that are relevant for a clear understanding of the present methods, systems, and apparatuses, while eliminating, for the purpose of clarity, many other elements found in software and computing systems. One of ordinary skill in the art may recognize that other elements and steps may be desired or required in implementing the present methods, systems, and apparatuses. However, because such elements and steps are well known in the art, a discussion of such elements and steps would not facilitate a better understanding of the present application and thus is not provided herein. The disclosure herein is directed to all such variations and modifications to such elements and elements known to those skilled in the art.

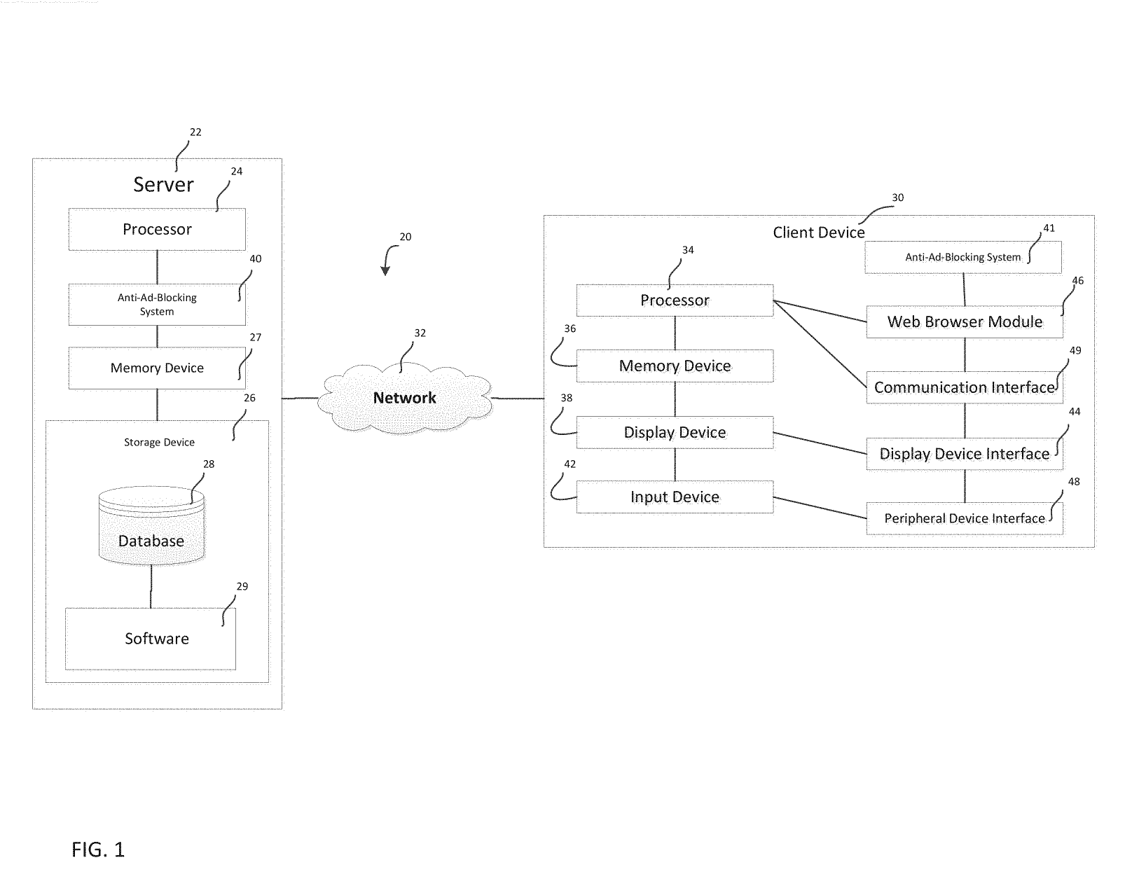

Methods, systems, and apparatuses are described herein for bypassing ad-blocking technology. FIG. 1 illustrates an embodiment of an example system 20 that implements the anti-ad-blocking system 40 described herein. As shown in FIG. 1, the system 20 includes a server 22, which may further include a processor 24, a memory device 27, a storage device 26, a database 28, software 29, and the anti-ad-blocking system 40. The server 22 may also be associated with, or incorporated into, any suitable type of computing device, such as, for example and without limitation, a personal computer, a programmable logic controller, or a mobile computing device. The server 22 is in communication with one or more client devices 30, which may be directly associated with the server 22, such as through a direct connection (either wired or wireless) or by being part of the same machine. The server 22 may include a communications port, a wired transceiver, a wired transmitter, a wired receiver, a wireless transceiver, a wireless transmitter, a wireless receiver, or a network card. The server 22 may be capable of communicating using technologies such as Ethernet, fiber optics, microwave, satellite, Public Switched Telephone Network (PTSN), DSL (Digital Subscriber Line), Broadband over Power Lines (BPL), WLAN technology, wireless cellular technology, or any other appropriate technologies.

The server 22 may be implemented using cloud computing technologies. The server 22 may be implemented across various computing, processing, storage, memory, and database devices in the cloud. The server 22 may be accessible via cloud services platforms such as Amazon Web Services, Microsoft Azure, Rackspace, and the like.

The server 22 may further include the anti-ad-blocking system 40, which may be one component of a larger software application on the server 22. The anti-ad-blocking system 40 may reside entirely on the server 22, or may alternatively include certain sub-components that reside on an additional server or computing device, for example as part of software on the additional server or computing device. By way of further example, the anti-ad-blocking system 40 may reside in and be implemented with client-side code on the computing device. A user may interact with the anti-ad-blocking system 40 in accordance with any of the embodiments described herein.

The client device 30 may communicate with the server 22 through a network 32 via either a wired or wireless connection, as described in further detail below. The client devices 30 shown in FIG. 1 may be, for example and without limitation, a computing device such as a desktop computer, a laptop computer, a netbook, a tablet computer, a personal digital assistant (PDA), a cellular phone such as a smartphone, or any other appropriate device. The client device 30 may each include a processor 34, a memory device 36, a display device 38, an input device 42, and a web browser module 46 loading webp ages utilizing the anti-ad-blocking system 41, which may be in communication with one another and with any other associated components of the client device 30 using any suitable type of communication device, such as a data bus. The client device may further include a communication interface 49, peripheral device interface 48, display device interface 44, which may be coupled to or included within the other components described above, such as the display device 38 and the input device 42.

The memory device 36, 27 in the client device 30 and server 22, respectively, may be or include a device such as a Dynamic Random Access Memory (D-RAM), Static RAM (S-RAM), other RAM, a flash memory, or any other suitable computer-readable medium. The memory device 36 may also be part of or in communication with a storage device of another component in the system 20, such as the storage device 26 of the server 22. The storage device 26 may be or include a hard disk, a solid-state drive (SSD), a magneto-optical medium, an optical medium such as a compact disc-read only memory (CD-ROM), a digital versatile disk (DVD), a Blue-Ray disk (BD), or any other type of computer-readable medium or suitable device for electronic data storage.

The communication interface 49 in the client device 30 may be, for example and without limitation, a communications port, a wired transceiver, a wired transmitter, a wired receiver, a wireless transceiver, a wireless transmitter, a wireless receiver, or a network card. The communication interface 49 may be capable of communicating using technologies such as Ethernet, fiber optics, microwave, satellite, Public Switched Telephone Network (PTSN), DSL (Digital Subscriber Line), Broadband over Power Lines (BPL), WLAN technology, wireless cellular technology, or any other appropriate technologies.

The peripheral device interface 48 in the client device 30 may be configured to communicate with one or more peripheral devices, such as the user input device 42. The peripheral device interface 48 may operate using technologies such as, for example and without limitation, Universal Serial Bus (USB), PS/2, Bluetooth, infrared, serial port, parallel port, or any other appropriate technologies. The peripheral device interface 48 may receive input data from an input device 42 such as a keyboard, mouse, trackball, pointing stick, touch screen, touch pad, stylus pad, or other suitable devices.

The display device interface 44 in the client device 30 may be configured to communicate data to the display device 38. The display device 38 may be, for example and without limitation, a monitor or television display, a plasma display, a liquid crystal display (LCD), or a display based on a technology such as front or rear projection, light emitting diodes (LEDs), organic light-emitting diodes (OLEDS), or Digital Light Processing (DLP). The display device interface 44 may operate using technology such as Video Graphics Array (VGA), Super VGA (S-VGA), Digital Visual Interface (DVI), High-Definition Multimedia Interface (HDMI), or any other appropriate technologies. The display device interface 44 may communicate display data from the processor 34 to the display device 38 to be displayed by the display device 38. The display device 38 may be external to the rest of the client device 30 and coupled to the client device 30 via the display device interface 44. Alternatively, the display device 38 may be included in the client device 30 and may be part of the same component as the input device 42, such as a touch screen display.

The web browser module 46 shown in FIG. 1 may include and/or communicate with one or more sub-modules that perform functionality such as rendering HyperText Markup Language (HTML) (including HTML5), rendering raster and/or vector graphics, executing JavaScript, and/or rendering multimedia content. The web browser module 46 or its sub-modules may also implement technologies such as Rich Internet Application (RIA), Adobe Flash, Microsoft Silverlight, or any other appropriate multimedia technologies. These multimedia technologies may be implemented using one or more web browser plug-in modules and/or by using one or more sub-modules within the web browser module 46 itself. The web browser module 46 may load webpages utilizing the anti-ad-blocking system 41.

As discussed above, the storage device 26 of the server 22 shown in FIG. 1 may include a database 28, which may be spread across one or more non-transitory computer-readable mediums, and may be or include one or more relational databases, hierarchical databases, object-oriented databases, one or more flat files, one or more spreadsheets, and/or one or more structured files. The database 28 may be managed by one or more database management systems, which may be based on a technology such as, for example and without limitation, Microsoft SQL Server, MySQL, PostgreSQL, Oracle Relational Database Management System (RDBMS), a NoSQL database technology, or any other appropriate technologies. The database may include a number of different types of data that are used by the server 22, which may be in communication with a client device over a network 32 including but not limited to the Internet, a wireless local area network (WLAN), and/or a cellular network. The database 28 may further be in communication with software 29 of the server 22, which may operate in conjunction with the anti-ad-blocking system 40, or make up a component of the anti-ad-blocking system 40.

An instance of the computing devices, including the exemplary client devices 30 and server 22 shown in FIG. 1, may be configured to perform any feature or any combination of features and methods described herein. Alternatively or additionally, the memory device 36 and/or the storage device 26 of the client device 30 and server 22 respectively may store instructions, which when executed by the processor 24, 34, cause the processor 24, 34 to perform any feature or any combination of features and methods described herein. Furthermore, each or any of the features and methods described herein may be performed by the processor 24, 34 in conjunction with the memory device 36, web browser module 46, communication interface 49, peripheral device interface 48, display device interface 44, and/or storage device 26. Specifically, the server 22 may be used to run the anti-ad-blocking system 40, and the client device 30 may be in communication with the anti-ad-blocking system 40 over the network 32.

As used herein, the term “processor” in reference to the processors 24, 34 of the server 22 and client device 30 broadly refers to any unit, module, or machine capable of executing a sequence of instructions, such as, for example and without limitation, a single-core or multi-core processor, a general purpose processor, a special purpose processor, a conventional processor, a Graphics Processing Unit (GPU), a digital signal processor (DSP), one or a plurality of microprocessors, one or more microprocessors associated with a DSP core, a controller, a microcontroller, one or more Application Specific Integrated Circuits (ASICs), one or more Field Programmable Gate Array (FPGA) circuits, any other type of integrated circuit (ID), a system-on-a-chip (SOC), a Complex Instruction Set Computer (CISC), a Reduced Instruction Set Computer (RISC), or a state machine.

As used herein, the term “non-transitory computer-readable medium” broadly refers to any storage medium that may store or transfer information, including volatile, nonvolatile, removable, and non-removable media. Examples of a computer-readable medium include, but are not limited to, a register, a cache memory, an electronic circuit, a fiber optic medium, a Read Only Memory (ROM), a semiconductor memory device (such as a D-RAM, S-RAM, or other RAM), a magnetic medium (such as a hard disk drive, a tape drive, a magneto-optical medium, or a floppy drive), a flash memory medium (such as a USB flash drive or a flash memory card), a flash based or D-RAM based solid-state drive (SSD), an optical disk (such as CDs, DVDs, or BDs), or any other suitable device for electronic data storage.

Although the methods and features of the present application are described herein as being performed using the example architecture of FIG. 1 the present method and features may be performed, mutatis mutandis, using any appropriate architecture or environment. For example and without limitation, anti-ad-blocking system 40 features described herein may be implemented using cloud computing technologies. Additionally, the components of the server 22 may be included as part of, or the same components as, those of the client device 30, such that the steps and operations described below as being performed by the server 22 are performed locally on the client device 30 instead. Furthermore, although the web browser module 46 in the client device 30 is described herein as implementing specific web browser technologies, it should be understood that the features described herein as performed by the web browser module 46 may alternatively or additionally be implemented using a specific purpose application, including but not limited to an application that is configured to run on an operating system such as Microsoft Windows, Apple OS X, Unix, Linux, Android, Windows Mobile, Apple iOS, or any other appropriate general purpose or mobile operating system.

Increasingly, users are utilizing ad-blocking technology installed on their computers (usually through a browser extension, e.g. AdBlock, AdBlock Plus, uBlock) to avoid seeing advertisements that are placed on websites in order to generate ad revenue for the website publishers. This results in reduced revenues for the publishers, many of which rely on advertisements on their sites as their sole source of revenue. In addition, ad-blocking technology may interfere with the normal operation of websites, as some ad-blockers may erroneously block content that it identifies as advertising-related, even when that is not the case, resulting in the website not being properly loaded or displayed.

Ad-blocking technology usually works in one of two ways, sometimes implementing both methods with the steps of the second method occurring after the steps of the first method. The first method for blocking advertising content utilizes a blacklist of rules to match against network requests for resources such as scripts, images or other content on a webpage (i.e. filtering out content by specific media types). Once a request matches the blacklist, it is blocked from connecting out, either by cancelling the request entirely or pointing the request to a different location. The content is therefore not shown to the end user. In addition to ad-blocker software implemented as a browser extension, other ad-blockers can be a separate standalone application installed on the user's computer, which may utilize a HTTP proxy or web proxy to filter content associated with unwanted advertisements. These programs work by filtering content before it is displayed on the user's browser. Ad-blockers may also utilize domain name system (DNS) manipulation, DNS cache, or DNS filtering to block access to certain domains associated with ad servers or other advertising material, so that content from those domains cannot be loaded.

The second method for blocking advertising content utilizes a blacklist of rules to match against HTML elements on the page (i.e. via selectors). Specifically, the ad-blocker may recognize particular text or other expressions within code associated with an ad tag, and in turn utilize the style sheet, or other methods, to target those ad tags and instruct the webpage's code to hide the other elements on the page, resulting in the advertising material not being displayed by the user. The style sheets may be generated dynamically for each page that the user visits. Sometimes the ad-blockers generates the style sheet before the elements on the page is loaded, and sometimes it's done afterwards, in either case, the style sheet can be used to hide the ad-related content on a page to prevent ads from being displayed to the user.

The first method described above is often the “first line of defense” for ad-blockers, as it completely stops the network request from going through and the advertising content from being retrieved to be rendered or displayed on a website. The second method described above is often the backup if certain advertising content bypasses that first line of defense. In other words, even if the network request to retrieve advertising or other content is successfully completed, the second method may still stop that content from being rendered and displayed on the webpage.

For companies and publishers attempting to combat ad-blockers, getting past that initial hurdle of that first line of defense is important because once the anti-ad-blocking system is able to get the network request through the ad-blocker, the anti-ad-blocking system has the advertising content that is to be rendered. Further, there are various ways of getting around the second ad-blocking method in order to render the advertising content on the webp age without it being blocked. For example, IDs or class names of the advertising content may be changed to infinite combinations that are not accounted for by the ad-blockers and their style sheets, or by selectively disabling the stylesheets generated on the webpage by the ad-blockers.

There are several known solutions for overcoming ad-blockers that utilize a blacklist of rules to match against network requests for resources scripts, images or other content on a webp age for blocking content from certain serving domains. For example, the following methods are currently being used for combating the first line of defense for ad-blockers:

(1) Using WebSockets so that the ad requests/network requests are routed through the WebSockets (which are blocked by some browsers, but not blocked in Chrome). However, some ad-blockers have figured out ways to block most WebSocket requests and run it through their filters, limiting the effectiveness of this method.

(2) Another method redirects advertising materials and other content from the original serving domain through a proxy server so that the ads appear to be served from a different domain that is not on the blacklist of the ad-blocker. By utilizing components that detect ad-blockers and forward blocked advertising calls to a proxy that retrieves the requested advertisements and reintroduces them for rendering, those advertising network calls are successfully completed. In this manner, the content is not blocked by the ad-blocker and may be served and loaded onto the webpage. The requests may be proxied through either the ad-blocking solution company's own servers or through the website publisher's own servers. In order for this solution to be effective, the domains of those proxy servers must remain off the ad-blockers' blacklist so that requests from those proxy servers cannot be blocked. In addition, as discussed in further detail below, this results in a cat and mouse scenario where ad-blockers continuously add new domains to their blacklists associated with proxy servers used to bypass ad-blockers, which means companies that utilize their solution must also continuously purchase, setup, and implement new domains to route network requests through. In addition to the added expense, this also adds operational and scaling difficulties to this method, and causes interruptions and downtime to publishers every time the advertising content on their pages become blocked again.

(3) Registering new domains to route the ad requests/traffic through every time a domain is added to an ad-blocker's blacklist (this also applies to solution #2 above, as sometimes certain domains from an ad-blocking solution company's own servers will get blocked). This solution may be very cumbersome and expensive, as having to register a new domain every time one gets blocked is not financially viable or scalable, and has the same downsides discussed above with respect to solution #2.

While these three example solutions may overcome the first method of ad-blocking (the “first line of defense” method utilizing a blacklist of rules to match against network requests for resources scripts, images or other content on a webpage), they do not address the second method of ad-blocking. These solutions are deficient with respect to the second method of ad-blocking because after the advertising content is served through a different proxy domain and allowed to be included in the content being loaded on the webp age, a dynamically generated style sheet may still recognize content (or elements from such content) that is associated with unwanted ads, and the ad-blocker would then block that content from being displayed to the user through the rules in the style sheet. However, as discussed above, there are other ways of getting around the second method of ad-blocking, and bypassing the first method is the main hurdle.

The other limitation to these known solutions is that they only provide short term solutions for bypassing ad-blockers. These solutions engage in an ongoing cat and mouse game to overcome the first method of ad-blocking, where each one of the known methods have known limitations as described above, and every time an ad-blocker catches on to what is being done to circumvent the ad-blockers using WebSockets or proxying web traffic, more rules are added to their blacklist to block those network requests. These methods are also unattractive to website publishers, as every time an ad-blocker catches on to a method of bypassing their ad-blocking technology, the solution become ineffective and the website publishers have to deal with downtime or the time and expense of setting up an alternate ad-block bypassing solution, instead of focusing on content creation and the other aspects of running their businesses. This is especially onerous for website publishers who attract visitors through a paid traffic model, through which the publisher places links to their website content as advertisements on other third-party web properties, and pay a fee each time a visitor clicks on that link and is directed to the publisher's site. For those publishers, it is imperative to their business model to generate sufficient advertising revenue from that paid visitor's single visit to offset the cost for attractive that visitor to their site. Accordingly, if the website publisher is relying on an anti-ad-blocking solution that fails, but they cannot react quickly enough to stop paying for visitors to be directed to their site, they will continue incurring those costs while being unable to make any revenues by showing ads to those users and it is a direct impact on their bottom line.

The present anti-ad-blocking system 40 addresses the challenges and shortfalls discussed above with known ad-blocking solutions, and bypasses both the first and second ad-blocking methods discussed above by utilizing Binary Large Objects (BLOBs). A BLOB object represents a file-like object of immutable, raw data and is a feature built into most browsers. Due to the way that the present anti-ad-blocking system 40 is configured and the fact that BLOB objects are an integral browser feature, it is difficult for ad-blockers to block advertising content retrieved and rendered through the present system 40.

The URL.createObjectURLO static method creates a DOMString containing a uniform resource locator (URL) representing the object given in parameter. The URL lifetime is tied to the document in the window on which it was created. The new object URL represents the specified File object or BLOB object.

XMLHttpRequest is an API that provides client functionality for transferring data between a client and a server. It provides an easy way to retrieve data from a URL without having to do a full page refresh. This enables a Web page to update just a part of the page without disrupting what the user is doing. XMLHttpRequest is used heavily in AJAX programming.

The File interface in the web APIs of browsers make it possible for browsers to access or load a file without making a network call to a server, but instead upload binary data of a file with content. When accessing a BLOB, a temporary “BLOB URL” may be created on a webpage in place of a script that would normally make a request to a server to retrieve the desired content to be rendered on the web page.

The anti-ad-blocking system 40 for bypassing ad-blockers inserts an iframe on a webpage or HTML document in which to load a BLOB URL. Iframes are created using the HTML <iframe> tag, which defines a location on an HTML document in which a separate HTML document may be displayed. The HTML code containing an image tag or script tag may then be loaded through that BLOB URL in the iframe. Because the BLOB URL is used, the network request is not blocked. Once the anti-ad-blocking system 40 retrieves the advertising or other content from the successful network request, it may be rendered inside of the iframe or outside of the iframe onto the main webpage. The content is successfully rendered and displayed despite the presence of ad-blocking technology on the user's device because browsers such as Chrome allow web extensions, of which the vast majority of ad-blockers are, to block content through blocking network requests, but these browsers do not allow it for the BLOB protocol. As a result, the anti-ad-blocking system 40 bypasses both the first and second methods of ad-blocking described above. Once a BLOB URL that is associated with the iframe is used, advertising content may be retrieved and rendered within the iframe without being blocked or hidden by an ad-blocker's stylesheet restrictions.

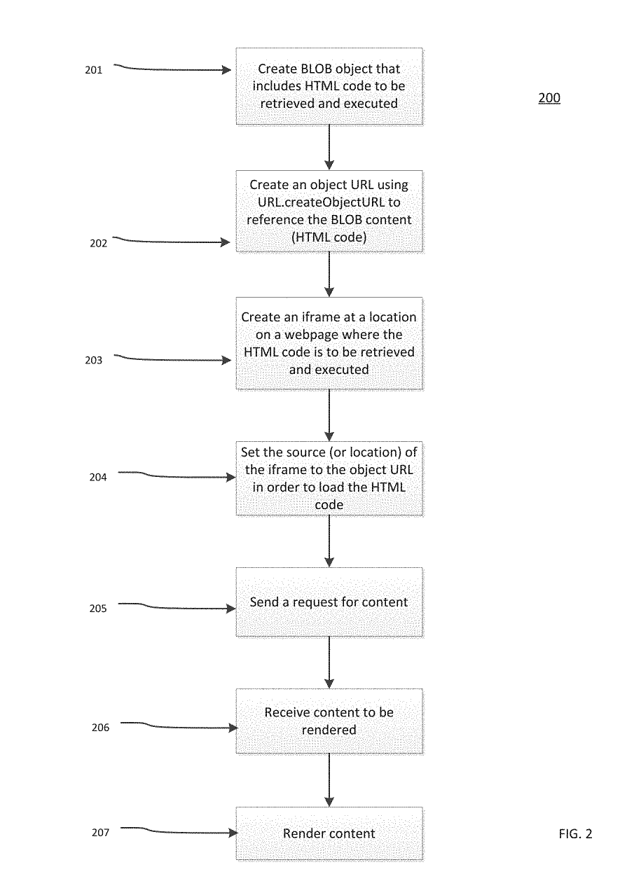

FIG. 2 is an example flow diagram of the process 200 that runs the anti-ad-blocking system 40, which may be performed in accordance with one example embodiment and may be used in combination with any of the embodiments described herein. Referring to FIG. 2, the anti-ad-blocking system 40 may create a BLOB object that includes HTML code that is to be retrieved and executed 201. The anti-ad-blocking system may then create an object URL 202 using URL.createObjectURL to reference the BLOB content, which is the HTML code included in the BLOB object. The anti-ad-blocking system may then create an iframe 203 at a location on a webpage where the HTML code is to be retrieved and executed, corresponding to the location where advertising content should be displayed on the webpage. The anti-ad-blocking system may set the source (or location) of the iframe to the object URL 204 in order to load the HTML code. Then, on a condition that the HTML code is executed, the anti-ad-blocking system may send a request for content 205. The anti-ad-blocking system may then receive content to be rendered 206 and render the content via the web browser 207. As a result, when HTML code is executed in accordance with the process of FIG. 2, the content requested by the executed HTML code is rendered, and any requests made by the executing HTML code bypass the webRequest filters that any ad-blocking technology may use in order to prevent connections from being made.

Because the anti-ad-blocking system 40 has access to the parent context after following the process of FIG. 2, additional code and content may be used either in the context of the new iframe created in the process of FIG. 2 or pushed up to one of the parent frames for execution, allowing ads to be rendered and to bypass any ad-blocking technology. For example, after following the anti-ad-blocking system process of FIG. 2, XMLHttpRequest, SWFHttpRequest, or other same/cross-origin transport methods may be executed in order to retrieve JavaScript and Cascading Style Sheets (CSS) code to be executed and/or HTML code to be displayed.

In another example, following the anti-ad-blocking system process of FIG. 2, JavaScript Object Notation with Padding (JSONP) may be used to make JavaScript requests with a callback in order to retrieve JavaScript and CSS code to be executed and/or HTML code to be displayed.

JavaScript requests may also be made in order to retrieve JavaScript and CSS code to be executed and/or HTML code to be displayed. This code may then run in the frame context. However, since the anti-ad-blocking system 40 has access to the parent context after following the anti-ad-blocking system 40 process of FIG. 2, the JavaScript requests may push up code to one of the parent frames for execution, ads to be rendered and bypass any ad-blocking technology.

After following the anti-ad-blocking system 40 process of FIG. 2, WebSocket requests may be made in order to retrieve JavaScript and CSS code to be executed and/or HTML code to be displayed.

After following the anti-ad-blocking system 40 process of FIG. 2, object wrappers in the Document Object Model (DOM) including but not limited to Element.prototype.appendChild and Element.prototype.insertBefore, may be modified to automatically set a newly created iframe's source to a BLOB URL, so that when data is written into that iframe, it has the potential to bypass any type of ad-blocking technology. These object wrapper overrides may be pushed down into the created iframe as well so that iframes created in the iframe (etc. to infinity) would do the same.

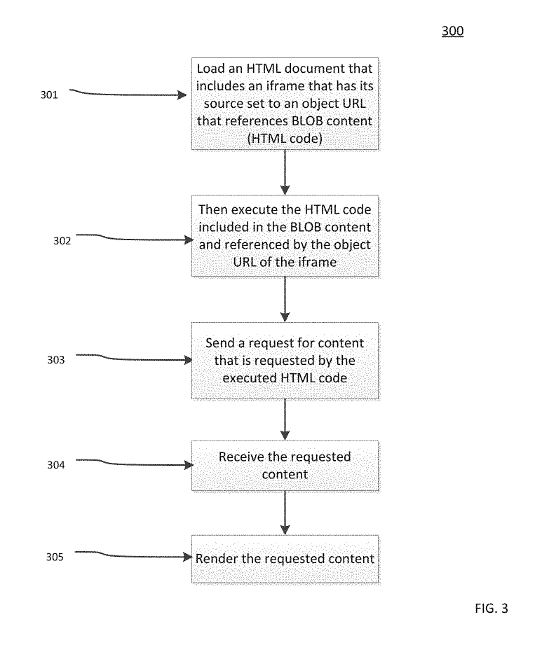

FIG. 3 is an example flow diagram of the process 300 that runs the anti-ad-blocking system performed by a client device 30 in accordance with another example embodiment, which may be used in combination with any of the embodiments described herein. The client device may load an HTML document that includes an iframe that has its source set to an object URL that references BLOB content 301, which includes HTML code. The client device may then execute the HTML code included in the BLOB content 302 and referenced by the object URL of the iframe. The client device may then send a request for content 303 that is requested by the executed HTML code. The client device may then receive the requested content 304 and render, via a web browser, the requested content 305 including content that bypasses any ad-blocking technology.

Having thus described various embodiments of the present system 20 and the anti-ad-blocking system 40 in detail, it is to be appreciated and will be apparent to those skilled in the art that many physical changes, only a few of which are exemplified in the detailed description above, may be made in the methods and apparatuses described herein without altering the inventive concepts and principles embodied herein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

Although features and elements are described above in particular combinations, it is to be appreciated that each feature or element can be used alone or in any combination with or without the other features and elements. Any single embodiment described herein may be supplemented with one or more elements from any one or more of the other embodiments described herein. Any single element of an embodiment may be replaced with one or more elements from any one or more of the other embodiments described herein. For example, each feature or element as described herein with reference to any one of FIGS. 1-3 may be used alone without the other features and elements or in various combinations with or without other features and elements from each or any combinations of the other figures from FIGS. 1-3. Each or any combination of features described herein with reference to FIGS. 1-3 may be considered optional. Sub-elements of the methods and features described herein with reference to FIGS. 1-3 may be performed in any arbitrary order (including concurrently) in any combination or sub-combination.

What is claimed is:

1. A method for use in a computing device, the method comprising:
creating, by a processor, a Binary Large Object (BLOB) object, wherein the BLOB object includes HyperText Markup Language (HTML) code to be executed;
creating, by the processor, an object uniform resource locator (URL) that references the HTML code;
creating, by the processor, an iframe at a location on an HTML document to render content;
setting, by the processor, a source of the iframe to the object URL;
executing, by the processor, the HTML code
sending, by a communication interface in response to the executed HTML code, a request for content; and
receiving, by the communication interface, content to be rendered via a web browser.

2. The method of claim 1, further comprising:
retrieving, via XMLHttpRequest, JavaScript code and Cascading Style Sheets (CSS) code to be executed and displayed in the iframe or a parent frame.

3. The method of claim 1, further comprising:
retrieving, via JavaScript Object Notation with Padding (JSONP), JavaScript code and Cascading Style Sheets (CSS) code to be executed and displayed in the iframe or a parent frame.

4. The method of claim 1, further comprising:
retrieving, via WebSockets, JavaScript code and Cascading Style Sheets (CSS) code to be executed and displayed in the iframe or a parent frame.

5. The method of claim 1, further comprising:
modifying Document Object Model (DOM) wrappers to set the iframe source to a BLOB URL.

6. A computing device, the computing device comprising:
a processor configured to create a Binary Large Object (BLOB) object, wherein the BLOB object includes HyperText Markup Language (HTML) code to be executed;
the processor further configured to create an object uniform resource locator (URL) that references the HTML code;
the processor further configured to create an iframe at a location on an HTML document to render content;
the processor further configured to set a source of the iframe to the object URL;
the processor further configured to execute the HTML code;
a communication interface configured to send a request for content based on the executed HTML code; and
the communication interface further configured to receive content to be rendered via a web browser.

7. The computing device of claim 6, further comprising:
the processor further configured to retrieve, via XMLHttpRequest, JavaScript code and Cascading Style Sheets (CSS) code to be executed and displayed in the iframe or a parent frame.

8. The computing device of claim 6, further comprising:
the processor further configured to retrieve, via JavaScript Object Notation with Padding (JSONP), JavaScript code and Cascading Style Sheets (CSS) code to be executed and displayed in the iframe or a parent frame.

9. The computing device of claim 6, further comprising:
the processor further configured to retrieve, via WebSockets, JavaScript code and Cascading Style Sheets (CSS) code to be executed and displayed in the iframe or a parent frame.

10. The computing device of claim 6, further comprising:
the processor further configured to modify Document Object Model (DOM) wrappers to set the iframe source to a BLOB URL.

11. A method for use in a computing device, the method comprising:
loading, by a processor, a HyperText Markup Language (HTML) document, wherein the HTML document includes an iframe, wherein the iframe has its source set to an object uniform resource locator (URL), wherein the object URL references a Binary Large Object (BLOB) content that includes HTML code;
executing, by the processor, the HTML code included in the BLOB content and referenced by the object URL of the iframe;
sending, by a communication interface, a request for content;
receiving, by the communication interface, the requested content; and
render, via a web browser, the requested content.

12. The method of claim 11, further comprising:
retrieving, via XMLHttpRequest, JavaScript code and Cascading Style Sheets (CSS) code to be executed and displayed in the iframe or a parent frame.

13. The method of claim 11, further comprising:
retrieving, via JavaScript Object Notation with Padding (JSONP), JavaScript code and Cascading Style Sheets (CSS) code to be executed and displayed in the iframe or a parent frame.

14. The method of claim 11, further comprising:
retrieving, via WebSockets, JavaScript code and Cascading Style Sheets (CSS) code to be executed and displayed in the iframe or a parent frame.

15. The method of claim 11, further comprising:
modifying Document Object Model (DOM) wrappers to set the iframe source to a BLOB URL.

16. A computing device, the computing device comprising:
a processor configured to load a HyperText Markup Language (HTML) document, wherein the HTML document includes an iframe, wherein the iframe has its source set to an object uniform resource locator (URL), wherein the object URL references a Binary Large Object (BLOB) content that includes HTML code;
the processor further configured to execute the HTML code included in the BLOB content and referenced by the object URL of the iframe;
a communication interface configured to send a request for content;
the communication interface further configured to receive the requested content; and
the processor further configured to render, via a web browser, the requested content.

17. The computing device of claim 16, further comprising:
the processor further configured to retrieve, via XMLHttpRequest, JavaScript code and Cascading Style Sheets (CSS) code to be executed and displayed in the iframe or a parent frame.

18. The computing device of claim 16, further comprising:
the processor further configured to retrieve, via JavaScript Object Notation with Padding (JSONP), JavaScript code and Cascading Style Sheets (CSS) code to be executed and displayed in the iframe or a parent frame.

19. The computing device of claim 16, further comprising:
the processor further configured to retrieve, via WebSockets, JavaScript code and Cascading Style Sheets (CSS) code to be executed and displayed in the iframe or a parent frame.

20. The computing device of claim 16, further comprising:
the processor further configured to modify Document Object Model (DOM) wrappers to set the iframe source to a BLOB URL.
